(19) United States
(12) Patent Application Publication
(10) Pub. No.: US 2013/0142911 A1
(43) Pub. Date: Jun. 6, 2013

(54) PRE-PACKAGED MEAL OF FORTIFIED MACARONI AND CHEESE, AND FORTIFIED RICE AND BEANS

(71) Applicants: Floyd V. Hammer, Union, IA (US); Stephen T. Popper, Naples, FL (US); Matthew A. Hammer, Grundy Center, IA (US)

(72) Inventors: Floyd V. Hammer, Union, IA (US); Stephen T. Popper, Naples, FL (US); Matthew A. Hammer, Grundy Center, IA (US)

(21) Appl. No.: 13/706,933

(22) Filed: Dec. 6, 2012

Related U.S. Application Data
(60) Provisional application No. 61/567,462, filed on Dec. 6, 2011.

(51) Int. Cl. A23L 1/30; B65B 1/04

(52) U.S. Cl. CPC A23L 1/30; B65B 1/04
USPC 426/73; 426/72; 53/474

(57) ABSTRACT

A prepackaged, fortified meal provides a substantial portion of the daily recommended requirements, which can be adjusted depending upon the intended consumers for the meals. In a first embodiment, the meal contains macaroni, powdered cheese, soy, vitamins, and minerals. The cheese, vitamins and minerals are contained in a small package, and is added to a larger bag with the macaroni and soy. In a second embodiment, the meal contains rice, beans, soy, dehydrated vegetables, vitamins, minerals and seasoning. The vitamins, minerals and seasoning are contained in a small package, which is added to a larger bag with the rice, beans, soy and vegetables. The meals are cooked in boiling water before consumption.

### CROSS-REFERENCE TO RELATED APPLICATIONS

This application claims priority under 35 U.S.C. §119 to provisional application Ser. No. 61/567,462 filed Dec. 6, 2011, herein incorporated by reference in its entirety.

### BACKGROUND OF THE INVENTION

Pre-packaged meals are well-known, including meals fortified with vitamins and minerals for consumption by underfed and undernourished individuals. These individuals, including both young and old, reside around the world, including developing countries, as well as in North America. For example, Outreach, Inc. has been packaging and shipping rice and soy based protein meals since 2004. Meals of Hope is another provider of pre-package meals for needy people. These fortified meals are intended to provide at least a substantial portion of the recommended daily requirements for vitamins and minerals. In comparison, pre-packaged meals sold in grocery stores for consumer use typically provide minimal nutritional requirements.

Some people, and particularly children under the age of 5, do not like the taste of rice and soy meals, even if hungry and/or malnourished. Also, some meals do not appeal to different cultural groups. For example, many people do not care for the rice and soy meals, and others do not care for macaroni and cheese. Therefore, there is a need for an alternative meal which will appeal to the tastes of children and others.

There are two specific vitamin groups:

1) Water soluble type vitamins such as Vitamin B and Vitamin C which are not stored so they must be taken into the body every day; and

2) Fat-soluble Vitamins A, D, E and K which are stored in the body's fatty tissue and the liver.

The thirteen vitamin types are:

Vitamin C

Vitamin B1 (Thiamin)

Niacin

Riboflavin

Vitamin B6

Folic Acid (Folacin)

Vitamin B12 (Cobalamin)

Vitamin A

Vitamin D

Vitamin E

Vitamin K

Biotin

Pantothenic Acid

The main minerals the body requires are calcium, magnesium, iodine, chromium, phosphorus, iron, copper, selenium, fluoride and zinc.

Accordingly, a primary objective of the present invention is the provision of a pre-packaged meal fortified with protein, vitamins and minerals which appeals to different consumers.

Another primary objective of the present invention is the provision of a pre-packaged macaroni and cheese meal fortified with protein, vitamins and minerals.

Another objective of the present invention is the provision of a pre-packaged fortified macaroni and cheese meal which meets, or substantially meets, many of the recommended daily requirements for protein, vitamins and minerals.

A further objective of the present invention is the provision of a pre-packaged macaroni and cheese meal which is nutritionally enhanced with protein, vitamins and minerals and which appeals to the tastes of people of all ages, and particularly to children. Another primary objective of the present invention is the provision of a pre-packaged beans and rice meal fortified with protein, vitamins and minerals.

Another objective of the present invention is the provision of a pre-packaged fortified beans and rice meal which meets, or substantially meets, many of the recommended daily requirements for protein, vitamins and minerals.

A further objective of the present invention is the provision of a pre-packaged beans and rice meal which is nutritionally enhanced with vitamins and minerals and which appeals to the tastes of people of all ages, and particularly to children.

These and other objectives will become apparent from the following description of the invention.

### SUMMARY OF THE INVENTION

In one embodiment, a prepackaged macaroni and cheese meal is fortified with soy protein, vitamins and minerals so as to satisfy many recommended daily requirements. The meal includes a first package containing cheese, vitamins and minerals, and a larger second package which includes the first package as well as macaroni and soy protein. The protein, vitamins and minerals can be modified for different meal formulations, depending upon the consumer of the meal.

In a second embodiment, a prepackaged rice and beans meal is fortified with soy protein, vitamins and minerals so as to satisfy many recommended daily requirements. The meal includes a first package containing vitamins, minerals, and seasoning and a larger second package which includes the first package as well as rice, dehydrated vegetables, beans and dry soy protein. The protein, vitamins and minerals can be modified for meal formulations packages, depending upon the consumer of the meal.

### BRIEF DESCRIPTION OF THE DRAWINGS

FIG. 1 is a bar graph showing the nutrient content of one formulation for the fortified macaroni and cheese meal according to the present invention in comparison to Kraft's commercially available macaroni and cheese product, both for the general population consuming a 2000 calorie per day diet.

FIG. 2 is a bar graph showing the nutrient content of one formulation for the fortified bean and rice meal according to the present invention, in comparison to Zataran's commercially available bean and rice product, for the general population using a 2000 calorie/day diet.

FIG. 3 is a schematic layout of one example of packaging stations for the macaroni and cheese meals according to the present invention.

### DETAILED DESCRIPTION OF THE PREFERRED EMBODIMENTS

The meals of the invention include two alternative embodiments. The first embodiment is a fortified macaroni and cheese meal, which is often preferred domestically over rice and soy meals. The second embodiment is a fortified rice and beans meal, which is preferred domestically, as well. The fortified meals of the present invention is a pre-packaged meal, sealed and deliverable anywhere in the world for preparation and consumption.

In the macaroni and cheese meal, vitamin and minerals are packaged and sealed in a first or inner bag with powdered cheese. Soy protein and dry macaroni are combined in a second or outer bag, to which the first sealed bag is added. The second bag is then sealed and labeled. The label includes the date and location where the meal was packaged, so the complete history of the package can be tracked, including Lot number and Best if used by date.

In the rice and beans meal, vitamin, minerals and seasoning are packaged and sealed in a first or inner bag with any additional desired seasoning. The soy protein, rice, beans, and dehydrated vegetables are combined in a second bag, to which the first sealed bag is added. The second bag is then sealed and labeled. The label includes the Lot number and Best if used by date and other information, so the complete history of the package can be tracked.

Table 1 shows the DRI for the general population based on 2000 and 2500 calories per day. DRI is an industry standard established by the National Academy of Sciences, Institute of Medicine, Food & Nutrition Board. DRI varies for males and females, and for different age groups.

TABLE 1

| | | 2000 Calories | | 2500 Calories | |
|---|---|---|---|---|---|
| Total Fat | Less than | 65 | g | 80 | g |
| Saturated Fat | Less than | 20 | g | 25 | mg |
| Cholesterol | Less than | 300 | mg | 300 | mg |
| Sodium | Less than | 2400 | mg | 2400 | mg |
| Total Carbohydrates | | 300 | g | 3500 | mg |
| Dietary Fiber | | 25 | g | 3750 | g |

| | | |
|---|---|---|
| Calories per gram: Fat 9 • Carbohydrate 4 • Protein 4 | 30 | g |

The ingredients of the macaroni and cheese meal are: Enriched pasta [durum wheat semolina, niacin, iron, thiamin mononitrate (Vitamin B1), riboflavin (Vitamin B2), folic acid], cheese blend with vitamin mix [maltodextran, wheat flour, vitamin blend (salt, vitamins and minerals), whey, salt, natural flavors, dehydrated cheese blend [granular, blue (milk, cheese culture, salt, enzymes)], buttermilk solids, soybean oil, partially hydrogenated soybean oil, whey protein concentrate, lactose, sodium phosphate, citric acid, lactic acid, FD&C yellow 6 lake and FD&C yellow 5 lake], and vegetable protein product (soy flour) for labeling purposes, thus the package contains milk, soy and wheat.

The ingredients of the rice and beans are: rice blend: rice, soy flour, pre-cooked dehydrated pinto beans, dehydrated vegetables (carrot, onion, tomato, celery, cabbage, bell pepper); vitamin seasoning packet: salt, dextrose, maltodextrin, hydrolyzed soy protein, vegetable oil, onion powder; L-cystine citric acid, disodium inosinate, disodium guanylate, tri-calcium phosphate, magnesium aspartate, ascorbic acid, vitamin E acetate, ferricfumerate, biotin, vitamin A palmitate, niacin amide, calcium pantohinate, zinc oxide, manganese oxide, copper gluconate, vitamin D-3 supplement, phyridoxine hydrochloride, riboflavin, thiamin, hydrochloride, folic acid, Vitamin B-12 cyanocobalmin, potassium iodide natural flavors and turmeric. Thus for labeling purposes, the package contains soy ingredients.

The nutritional contents per serving of the formulation for fortified macaroni and cheese meal of the present invention is shown in Table 2 below, wherein the “Mix” column represents the dry food as packaged before preparation, and the “Prepared” column represents the values after the meal has been prepared. The meal preparation involves cooking of the dry macaroni in boiling water. Do not drain the water in order to retain the protein content. Then, 4-6 table spoons of salted butter, one quarter to one half cup of 2% milk, and the fortified powdered cheese are added to the cooked noodles to make six servings of 77 grams each. Table 1 also includes the percent of the daily recommended intake (DRI) of the vitamins and minerals in the formulation, both for the mix and the prepared conditions.

For comparison, Table 2 also shows the nutritional contents per serving for unfortified Kraft Macaroni and Cheese, as labeled on the product packaging (sold by Kraft Foods Global, Inc. of Northfield, Ill.), both for the packaged mix and as prepared. The Kraft product label only lists four of Applicant's 20 vitamins and minerals for the prepared Kraft meal.

TABLE 2

| Fortified | | | | | Kraft | | |
|---|---|---|---|---|---|---|---|
| Macaroni and Cheese Meal | | | | | Macaroni and Cheese | | |
| Nutritional Facts | | | | | | | |
| Serving size 2.08 oz (59 g) | | | | | | | |
| Servings per bag 6 | | | | | | | |
| Amount per serving | MIX | | PREPARED | | MIX | | PREPARED |
| Calories | 265 | | 355 | | 250 | | 290 |
| Calories from Fat | 5 | | 63 | | 20 | | 45 |
| % Daily Value* | | | | | | | |
| Total Fat | .5 | g/.8% | 7 | g/10% | 2.5 | g/4% | 8% |
| Saturated Fat | .01 | g/0.0% | 5 | g/25% | 1 | g/5% | 15% |
| Cholesterol | 0 | mg/0.0% | 21 | mg/7% | 10 | mg/3% | 5% |
| Sodium | 518 | mg/22% | 580 | mg/25% | 580 | mg/24% | 25% |
| Potassium | 200 | mg/4% | 217 | mg/5% | — | | — |
| Total Carbohydrates | 20 | g/6% | 20 | g/6% | 49 | g/16% | 17% |
| Dietary Fiber | 2 | g/7% | 2 | g/7% | 1 | g/4% | 4% |
| Sugars | 2 | g | 2.5 | g | 7 | g | |
| Protein (Option A)* | 5 | g/10% | 9 | g/18% | 9 | g | |

| | | | | |
|---|---|---|---|---|
| Protein (Option B)* | 9 | g | 13 | g |

| | MIX | PREPARED | | |
|---|---|---|---|---|
| Vitamin A | 36% | 47% | 0 | 4 |
| Vitamin C | 15% | 15% | 0 | 0 |
| Vitamin B12 | 40% | 40% | 20 | 25 |
| Calcium | 8% | 13% | 10 | 10 |
| Iron | 65% | 65% | | |
| Biotin | 40% | 40% | | |
| Folic Acid | 30% | 30% | | |
| Pantothenic Acid | 33% | 33% | | |
| Niacin | 43% | 43% | | |
| Vitamin D | 8% | 10% | | |
| Vitamin E | 33% | 40% | | |
| Thiamine | 55% | 55% | | |
| Riboflavin | 40% | 40% | | |
| Vitamin B6 | 25% | 25% | | |
| Phosphorus | 6% | 14% | | |
| Iodine | 40% | 40% | | |
| Magnesium | 10% | 10% | | |
| Copper | 30% | 30% | | |
| Zinc | 15% | 15% | | |
| Manganese | 5% | 5% | | |

Percent Daily Values based on a 2,000 calorie diet. Daily values may be higher or lower depending on your calorie needs.
*The protein values will vary depending on the pasta.

Table 3, below, shows the weight of various vitamins and minerals to be mixed with the powdered cheese for two different embodiments, A and B, of the macaroni and cheese meal. With Embodiment B, two servings of the macaroni and cheese will meet about 50% or greater of the DRI for adults with reduced amounts of iron and sodium.

TABLE 3
Milligrams of Vitamins and Minerals per 1 gram of the cheese

| | Embodiment A | Embodiment B |
|---|---|---|
| Calcium | 0.59 | 11 |
| Vit D | 0.000076 | 0.22 |
| Potassium | 2.3 | 52 |
| Vit C | 0.93 | 1.6 |
| Vit A | 29 | 17 |
| B12 | 0.000091 | 0.045 |
| Iron | 0.25 | 0 |
| Sodium | 46.82 | 25 |
| Vit E | 0.02 | 0.03 |

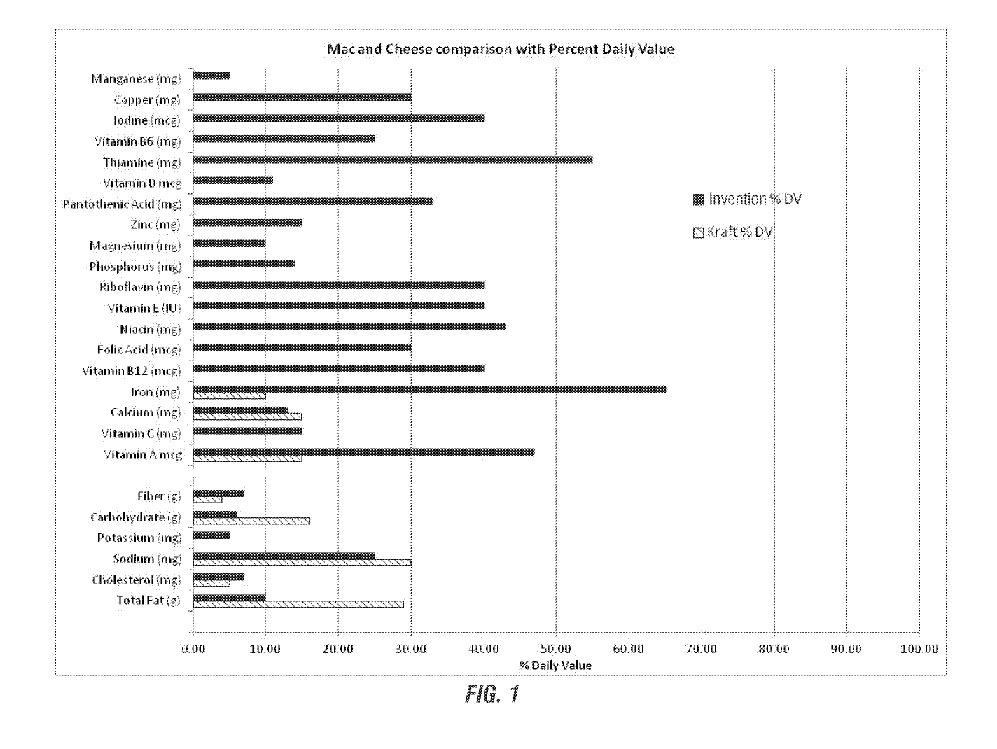

As seen in FIG. 1, the fortified macaroni and cheese meal of the present invention, Embodiment A provides at least 20-50% of the daily recommended amounts of most of the vitamins and minerals. In comparison, according to the Kraft product/label, only 8 vitamins and minerals are identified, at lower levels than the 21 vitamins and minerals for the macaroni and cheese meal of the present invention.

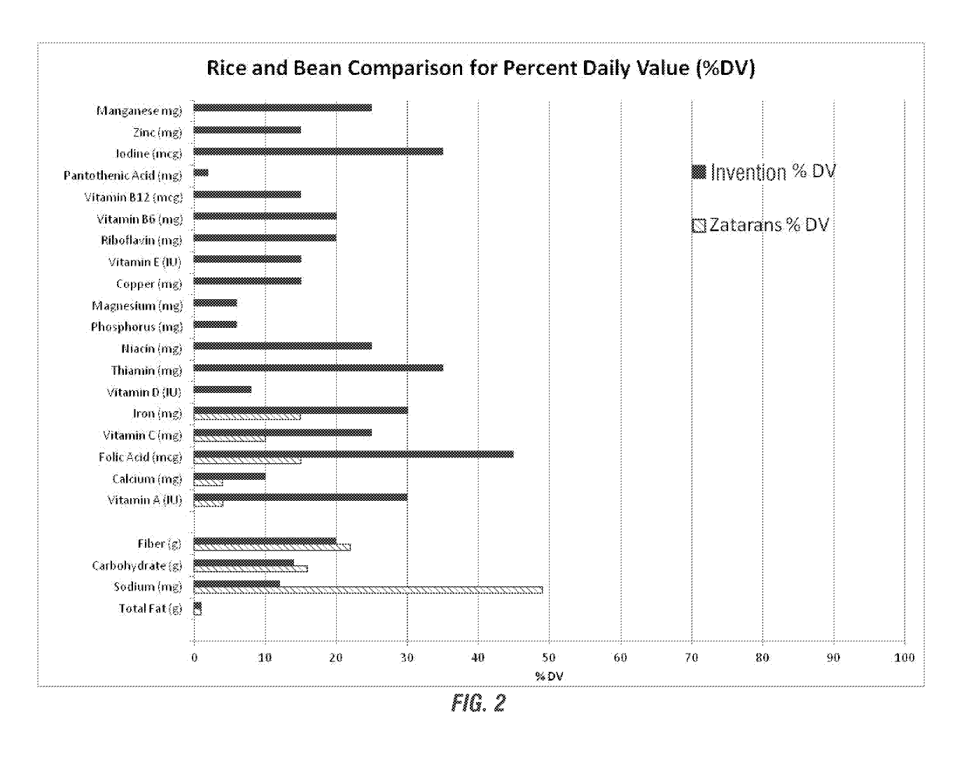

FIG. 2 compares the nutritional values of the 20 vitamins and minerals for the beans and rice meal of the present invention, versus the 8 listed vitamins and minerals of Zataran's commercial beans and rice meal.

Both the macaroni and cheese and the beans and rice meals of the present invention have a more complete nutritional profile which exceeds the Nutritional Facts labeling profile of the Kraft and Zataran's grocery store products. Both of Applicant's meals also have less sodium than the commercial products, which is a medical concern for some adults.

It is understood that changes to the vitamin, mineral and seasoning mix may be made to prevent deficiencies and/or potential toxicities, without departing from the scope of the present invention and/or to modify the flavor profile so as to be more acceptable to various cultures. The protein may also be modified. For example, the soy protein may be in a textured, granular, flour, or powdered form, and may be increased or decreased depending on the desired protein content. The butter may be increased to six tablespoons and the milk may be increased to half a cup, or alternatively, the butter can be reduced to flour tablespoons and the milk decreased to ¼ cup. The vitamin and mineral mix may be modified, such as shown in Embodiment B of Table 3. Also, there may be substitutes for the milk and butter which is added to the cooked macaroni and cheese. For example, powdered milk and butter can be included in the package, rather than being added later.

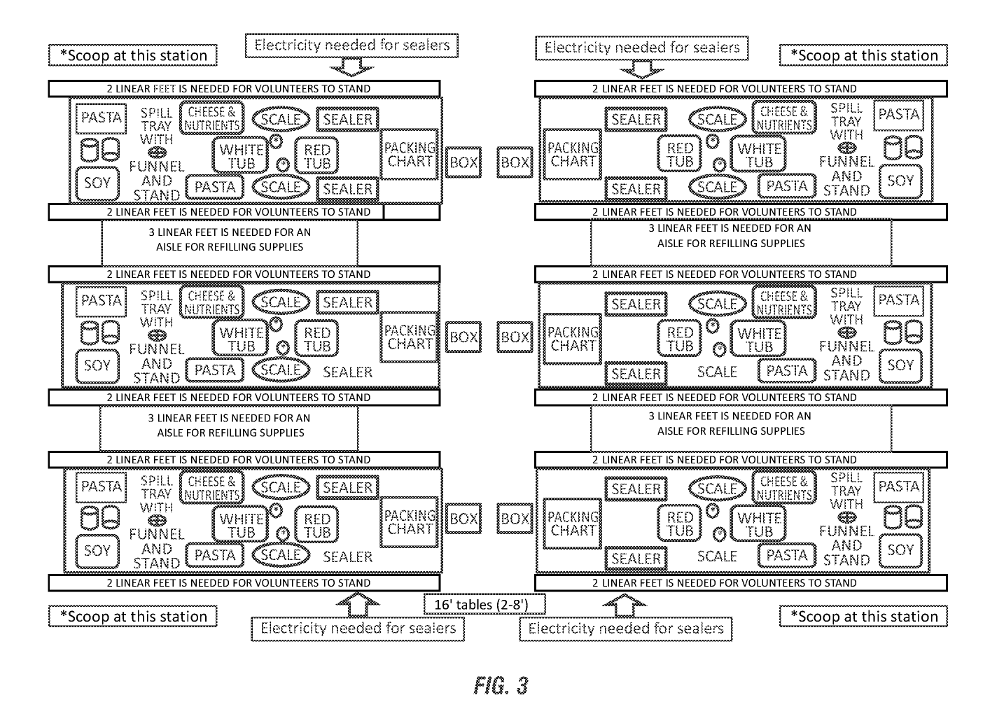

FIG. 3 shows a general layout for a plurality of tables used for packaging the macaroni and cheese meals. Each table has multiple stations, each attended by a different person.

Table 4 shows the nutritional content of the rice and beans meal. The meal preparation includes adding the rice, beans, and soy to 6-8 cups of boiling water, simmering for approximately 20 minutes. Then the packet of vitamins, minerals and seasoning is stirred into the cooked rice blend. Oil and/or other seasonings may also be added to enhance the flavor or calories.

TABLE 4
Fortified
Rice and Beans Meal

| Nutritional Facts | | |
|---|---|---|
| Serving size 2.08 oz (59 g) | | |
| Servings per bag 6 | | |
| Amount per serving | MIX | |
| Calories | 220 | |
| Calories from Fat | 5 | |
| % Daily Value* | | |
| Total Fat | 0.5 | g/1% |
| Saturated Fat | .0 | g |
| Cholesterol | 0 | mg/0% |
| Sodium | 280 | mg/12% |
| Total Carbohydrates | 43 | g/14% |
| Dietary Fiber | 5 | g/20% |
| Sugars | 2 | g |
| Protein | 11 | g |

| | MIX |
|---|---|
| Vitamin A | 30% |
| Vitamin C | 25% |
| Vitamin B12 | 15% |
| Calcium | 10% |
| Iron | 30% |
| Biotin | 4% |
| Folate | 45% |
| Pantothenic Acid | 2% |
| Niacin | 25% |
| Vitamin D | 8% |
| Vitamin E | 15% |
| Thiamine | 35% |
| Riboflavin | 20% |
| Vitamin B6 | 20% |
| Phosphorus | 6% |
| Iodine | 35% |
| Magnesium | 6% |
| Copper | 15% |
| Zinc | 15% |
| Manganese | 25% |

Table 5 below describes a packaging process using the table layout illustrated in FIG. 6 for preparing the pre-packaged fortified macaroni and cheese meals, according to the present invention. It is understood that the precise layout of the tables can be modified, if necessary, though the layout of FIG. 6 provides an effective and efficient packaging process utilizing 8-12 people at each table. The number of tables can be increased or decreased, depending on the number of people available for packaging the meals.

TABLE 5
The preferred process for meal packages
includes the following steps:
Cheese and Nutrients Station

| | |
|---|---|
| 1. | Place 1 unopened vitamin and cheese sachet into bag. |
| 2. | Place open end of bag under bottom of funnel. |

Soy Station

| | |
|---|---|
| 1. | Place 1 level scoop, (48 grams) of soy in the funnel. |

Pasta Station

| | |
|---|---|
| 1. | Place 2 scoops, (235 grams) of pasta in the funnel. Fill the scoop |
| | to just below the rim. Preferably, the pasta is the last ingredient |
| | added to the bag. |
| 2. | Carefully lower the bag and place in white tub A after all ingredients |
| | have been added. |

Weigh Station

| | |
|---|---|
| 1. | Turn scale on and put empty scale tray in place-let scale calibrate |
| | to “0”. Make sure scale is set to grams. |
| 2. | Place full bag into scale tray. MUST weigh between 353 and 354 |
| | grams. |
| 3. | If too heavy remove pasta from bag. If too light add pasta to bag. |
| 4. | Place bag in red tub B when weight is correct. |

Sealing Station

| | |
|---|---|
| 1. | Remove excess air from bag. |
| 2. | Place seal line of bag on seal bar and press down on sealing arm |
| | until sealer light comes on. |
| 3. | When sealer light goes off lift arm and check to make sure bag |
| | is sealed. |

Chart/Sticker Station

| | |
|---|---|
| 1. | Place a tracking or lot sticker having the package details on |
| | each bag next to the address for future tracing and back tracking. |
| 2. | Place two filled and sealed bags on each square of the packing |
| | chart, flattening them as they are stacked. |
| 3. | When each square has two bags, the box is ready to be packed. |

Box/Packing Station

| | |
|---|---|
| 1. | Layer 4 bags on bottom of box. Continue stacking in this manner |
| | until the chart is empty. There should be 36 bags. Tape boxes |
| | shut making sure a box sticker is affixed to the side. |

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed is:

1. A pre-packaged, fortified meal, comprising:
macaroni;
soy;
powdered cheese;
vitamins;
minerals;
the vitamins and minerals being selected according to an intended consumer of the meal;
the cheese, vitamins and minerals being packaged in a first bag; and
the macaroni, soy and first bag being combined in a second bag for storage and shipping.

2. The meal of claim 1 wherein the macaroni, soy, and blended cheese, vitamins and minerals are each traceable to a source of origination.

3. The meal of claim 1 wherein the vitamins include Vitamin A, Vitamin B6, Vitamin B12, Vitamin C, Vitamin D and Vitamin E, biotin, folic acid, pantothenic acid, niacin, thiamine, and riboflavin.

4. The meal of claim 1 wherein the vitamins are selected from a group consisting of Vitamins B12, D and E.

5. The meal of claim 1 wherein the minerals include phosphorus, iodine, magnesium, copper, zinc and manganese.

6. The meal of claim 1 wherein the minerals are selected from a group consisting of iodine and copper.

7. The meal of claim 1 wherein a majority of vitamins meet at least 30% of the DRI for the general population.

8. The meal of claim 1 wherein at least some of the minerals meet at least 20% of the DRI for the general population.

9. The meal of claim 1 wherein total fat is less than 1 gram per serving unprepared.

10. The meal of claim 1 wherein total saturated fat is less than 0.5 gram per serving unprepared.

11. The meal of claim 1 wherein total cholesterol is less than 5 grams per serving unprepared.

12. The meal of claim 1 wherein total carbohydrates is less than 25 grams per serving.

13. The meal of claim 1 wherein total sugars is less than 5 grams per serving.

14. An assembly line process for packaging meals, comprising:
providing a table with multiple worker stations;
positioning workers at the multiple stations;
positioning a bag beneath a funnel between two stations;
adding soy protein and pasta to the bag through the funnel;
adding pre-packaged cheese powder fortified with vitamins and minerals to the bag; and then
weighing the bag; then
adjusting the weight in the bag by adding or removing pasta if the weight is outside a predetermined range;
sealing the bag; and
placing the sealed bag in a box at the end of the table.

15. The process of claim 14 further comprising storing and shipping the boxed bags.

16. The process of claim 14 wherein the soy protein and pasta are measured before adding to the bag.

17. A pre-packaged, fortified meal, comprising:
rice;
beans;
soy;
vitamins;
minerals;
seasoning:
the vitamins and minerals being selected according to an intended consumer of the meal;
the vitamins, minerals and seasoning being packaged in a first bag; and
the rice, beans, soy and first bag being combined in a second bag for storage and shipping.

18. The meal of claim 17 wherein the rice, beans, soy, vitamins, minerals and seasoning are each traceable to a source of origination.

19. The meal of claim 17 wherein the vitamins include Vitamin A, Vitamin B6, Vitamin B12, Vitamin C, Vitamin D and Vitamin E, biotin, folic acid, pantothenic acid, niacin, thiamine, and riboflavin.

20. The meal of claim 17 wherein the minerals include phosphorus, iodine, magnesium, copper, zinc and manganese.

21. The meal of claim 17 wherein at least some of the vitamins meet at least 30% of the DRI for the general population.

22. The meal of claim 17 wherein at least some of the minerals meet at least 20% of the DRI for the general population.

23. The meal of claim 17 wherein total fat is less than 1 gram per serving.

24. The meal of claim 17 wherein total saturated fat is less than 0.5 gram per serving.

25. The meal of claim 17 wherein total cholesterol is less than 1 gram per serving.

26. The meal of claim 17 wherein total carbohydrates is less than 50 grams per serving.

27. The meal of claim 17 wherein total sugars is less than 5 grams per serving.

28. The meal of claim 17 further comprising dehydrated vegetables.
